(19) United States
(12) Patent Application Publication
(10) Pub. No.: US 2003/0108080 A1
(43) Pub. Date: Jun. 12, 2003

(54) Unidirectional curved ring lasers

(75) Inventor: Alex Behfar, Ithaca, NY (US)

Correspondence Address: JONES, TULLAR & COOPER, P.C., P.O. BOX 2266 EADS STATION, ARLINGTON, VA, 22202

(73) Assignee: BinOptics, Inc

(21) Appl. No.: 09/918,548

(22) Filed: Aug. 1, 2001

(51) Int. Cl. H01S 3/083

(52) U.S. Cl. 372/94

(57) ABSTRACT

A controllable, unidirectional ring laser having a reduced length includes at least one curved waveguide section, at least one partially transmitting facet, and a mechanism for producing unidirectional propagation of light within the waveguide cavity. The mechanism includes, in one embodiment, an external reflector which may be either planar or curved, in the path of emitted light from a waveguide facet. In another embodiment of the invention, the reflector is replaced by a source of light directed at the emitting facet of the waveguide, while another embodiment includes the use of an asymmetric element in the cavity. If desired, two unidirectional devices can be used selectively to produce a reversible waveguide.

### BACKGROUND OF THE INVENTION

The present invention relates, in general, to a method and apparatus for providing a unidirectional ring laser having a curved waveguide cavity, and more particularly to a ring laser having a cavity with at least one curved segment, a partially transmitting facet, and a mechanism for ensuring unidirectional propagation of light in the ring cavity.

Advances in current monolithic integration technology have allowed lasers of complicated geometry to be fabricated, including ring lasers with a variety of cavity configurations. Examples of such ring lasers are found in U.S. Pat. Nos. 4,851,368, issued Jul 25, 1989; 4,924,476 issued May 8, 1990; 5,132,983, issued Jul. 21, 1992; and 5,764,681, issued Jun. 9, 1998. These patents disclose traveling wave semiconductor lasers, and more particularly ring-type lasers utilizing straight legs intersecting at facets with some of the facets having total internal reflection and some permitting emission of laser light generated in the ring laser. They also disclose a method of forming the lasers as ridges on a substrate, and in particular disclose a chemically assisted ion beam etching process for this purpose.

A ring cavity laser possesses benefits that a Fabry-Perot cavity does not provide; for example, it produces lasing action with higher spectral purity than can be obtained with a Fabry-Perot cavity. Prior ring cavity lasers have relied on total internal reflection (TIR) facets as well as partially transmitting (PT) facets to propagate traveling waves within the laser which are emitted at selected facets. However, it was found that the use of TIR facets can lead to large optical cavities, and accordingly a new curved ring laser configuration that reduces or eliminates the reliance on TIR facets was developed, and is described in copending U.S. application Ser. No.______, filed by the herein-named applicant on even date herewith, and entitled “Curved Waveguide Ring Laser” (attorney docket JTC 104-128/BIN2) the disclosure of which is hereby incorporated herein by reference.

A unidirectional ring laser, because of its higher spectral purity, and because it has lower spatial and spectral hole burning, will have a lower noise than bidirectional rings. Further, because a unidirectional ring laser only has one output beam and because it is difficult to combine the two output beams of a bidirectional ring into a single output waveguide, a unidirectional ring shows greater power output in a particular direction, for the same power input, than does a bidirectional ring.

To fully exploit some of the beneficial characteristics of ring lasers, it is desirable to ensure in a deterministic fashion that the lasers are unidirectional. Additionally, one must be able to control the direction of lasing. This has been accomplished in the past by a variety of methods, including non-planar ring geometries and the use of an accousto-optic Q-switch. However, the most common, and effective, method requires the use of an expensive intracavity optical isolator. This device usually has a magnetic medium and utilizes the Faraday effect to introduce a non-reciprocal, or direction dependent, loss which produces in the ring laser a preferential direction of lasing. Although the isolator imposes unidirectional operation, it requires a magnetic field which adds to the size and cost of the isolator and does not allow the lasing direction to be conveniently and rapidly switched. Although such an isolator is used for large cavity gas, dye and solid state lasers, it cannot be used to control the new generation of integrated ring lasers.

Advances in current monolithic integration technology have allowed lasers of much more complicated geometry to be fabricated, including ring lasers with a variety of cavity configurations. These developments expand the prospective applications for integrated semiconductor lasers, and add the attractiveness of smaller size, greater manufacturability and reduced cost. However, the nature of such integrated monolithic lasers does not permit the introduction of a conventional optical isolator into the cavity. Therefore, a new technique for controlling ring lasers is needed to provide unidirectional operation in lasers utilizing any type of gain medium in any wavelength regime in the electromagnetic spectrum, and more particularly, a technique which can be employed with integrated semiconductor ring lasers having curved waveguide segments is needed. A desirable feature for such devices would be the provision of a structure which would permit easy and convenient switching of the lasing direction of the ring laser.

### SUMMARY OF THE INVENTION

In accordance with the present invention, a controllable, unidirectional ring laser having a reduced length is obtained by providing a cavity that consists of at least one curved waveguide section, at least one partially transmitting (PT) facet, and a mechanism for producing unidirectional propagation of light within the cavity.

The curved segment preferably joins at least two straight waveguide segments which are joined to form the PT facet, the curved waveguide serving as an optical waveguide to carry the light from one straight cavity segment to the other with low loss and to partially or completely eliminate the need for TIR facets in the formation of a ring laser.

In its simplest form, the ring cavity of the present invention combines a curved waveguide with two straight waveguides and a single PT facet to form a cavity in the shape of a teardrop, when viewed in top plan view. The facet serves as an emitting surface for the laser light, and the curved shape reduces the overall length of the cavity while still retaining the higher spectral purity that is a characteristic of ring cavities.

The ring cavity is turned into a unidirectional ring laser through the use of (a) a flat-shaped external mirror that is monolithically built with the ring laser, (b) an external source of light injection into the ring cavity, (c) an asymmetrical element incorporated within the ring cavity that is monolithically built with the ring laser, or (d) a ring laser that is combined with a curved-shaped external mirror that is monolithically built with the ring laser.

### BRIEF DESCRIPTION OF THE DRAWINGS

The foregoing, and additional objects, features and advantages of the present invention will be apparent to those of skill in the art from the following detailed description of preferred embodiments thereof, taken in conjunction with the accompanying drawings, in which:

FIG. 1 is a diagrammatic perspective illustration of a ring laser having one curved waveguide and one facet;

FIG. 2 is a diagrammatic top plan view of the laser of FIG. 1;

FIG. 3 is a diagrammatic illustration of the ring laser of FIG. 1, with a flat-shaped external mirror for producing unidirectional light propagation;

FIG. 4 is a diagrammatic illustration of the ring laser of FIG. 1, with a curved-shaped external mirror for producing unidirectional light propagation;

FIG. 5 is a diagrammatic illustration of the ring laser of FIG. 1, with an external source of light injection for producing unidirectional light propagation;

FIG. 6 is a diagrammatic illustration of the ring laser of FIG. 1 with an asymmetrical element integrated within the laser cavity for producing unidirectional light propagation;

FIG. 7 is a diagrammatic illustration of the ring laser with two facets and two curved cavity sections, with a flat-shaped external mirror for producing unidirectional light propagation;

FIG. 8 is a diagrammatic illustration of the ring laser of FIG. 7, with an external source of light injection for producing unidirectional light propagation; and

FIG. 9 is a diagrammatic illustration of the ring laser of FIG. 7, with an asymmetrical element integrated within the laser cavity for producing unidirectional light propagation.

### DESCRIPTION OF PREFERRED EMBODIMENTS

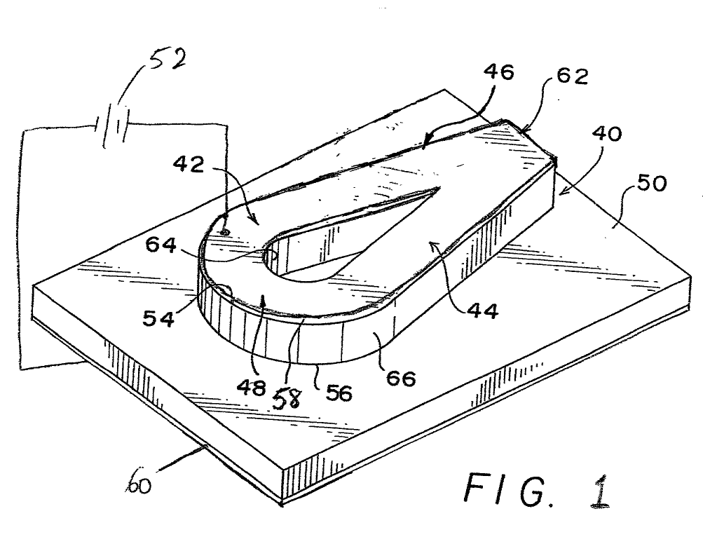

Turning now to a more detailed description of the invention, FIG. 1 illustrates a curved waveguide ring laser 40 that is the subject of the aforesaid patent application Ser. No.______,(JTC Docket 104-128/BIN2). This ring laser includes one curved cavity section 42 and two straight cavity sections 44 and 46, interconnected at 48 to form a teardrop-shaped laser cavity. As illustrated, the laser 40 preferably is formed as a monolithic structure on a substrate 50. Application of a potential across the waveguide cavity, from a power source such as battery 52 connected between the upper and lower surfaces 54 and 56 of the cavity, as by way of surface electrode 58 on the top surface 54 and electrode 60 on the back side of substrate 50, produces a lasing action within the body of the laser 40, creating optical traveling waves within the three sections 42, 44 and 46. The teardrop-shaped ring laser has a single facet 62 present at the intersection 48 of cavity sections 44 and 46, the surface of this facet being optically smooth, and is partially internally reflective.

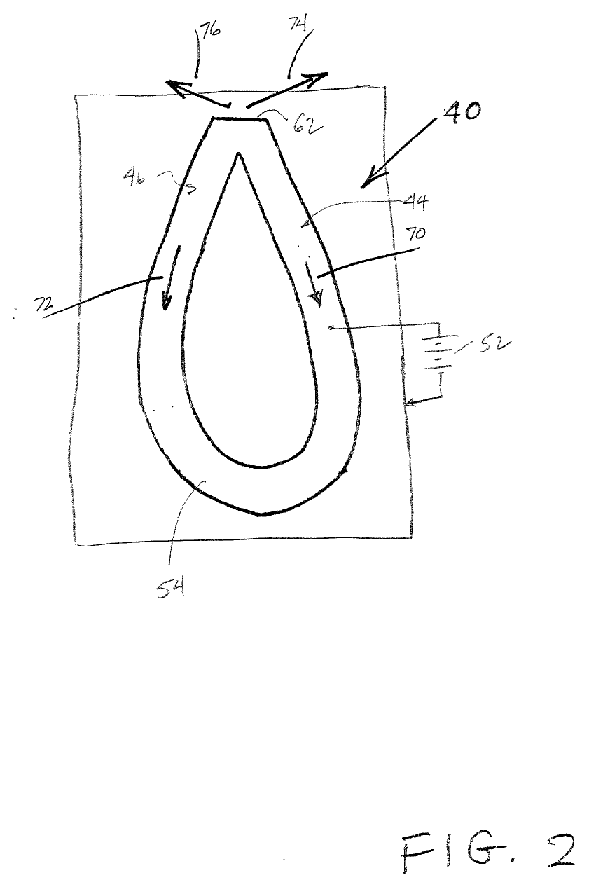

FIG. 2 illustrates a top plan view of the teardrop-shaped ring laser 40, with arrows 70 and 72 indicating that the laser can operate in either a clockwise (cw) mode or a counterclockwise (ccw) mode, respectively. The cw mode 70 results in an output beam 74 and beams strike to the surface of the facet 62 at such an angle that the ccw mode results in an output beam 76. This ring laser is an example of a bi-directional device where the cw and ccw modes are both operating and no one mode is substantially dominating the operation.

In a ring laser, unidirectional operation results when the laser is primarily operating in either a cw mode or a ccw mode. Below, several techniques for forcing curved cavity ring lasers into unidirectional operation are described.

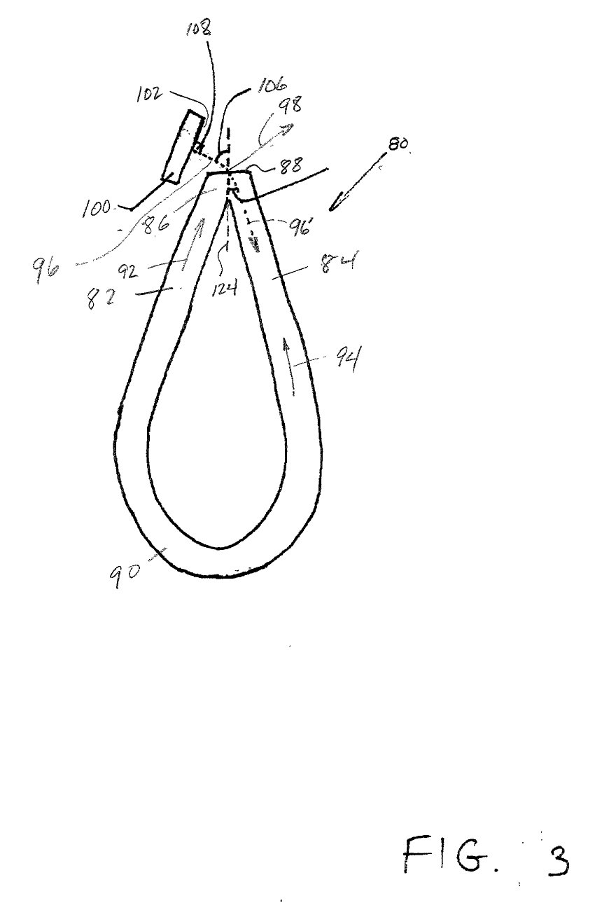

FIG. 3 is a diagrammatic illustration in top plan view of a curved waveguide unidirectional ring laser 80 which, in accordance with the present invention, includes linear cavity segments 82 and 84 joined together at corresponding first ends at a junction 86 on which is formed a facet 88. The second ends of the linear sections are joined together by a curved cavity section 90 to complete the ring laser. Facet 88 is partially internally reflective, with a selected portion of the light, such as the cw and ccw optical waves 92 and 94 propagating in the ring and being partially emitted from the facet 88 as output beams 96 and 98 in known manner. To provide unidirectional propagation of light in the manner described in U.S. Pat. No. 5,132,983, the disclosure of which is hereby incorporated herein by reference, an external reflective facet 100 is positioned adjacent the emitting facet 88, in the path of either one of the emitted beams 96 and 98. The reflective facet 100 has a flat surface 102 which is positioned to be perpendicular to the path of emergence of, for example, beam 96, to cause any light emerging along this path to be partially reflected back along the path of emergence, in a direction opposite to the direction of emergence of beam 96, as illustrated by dotted line 96′. Thus, light 94 traveling in a ccw direction in the ring cavity 80 and emerging from facet 88 as beam 96 will be reflected by surface 102 back along the path of emergence of beam 96 and back into the laser cavity with a direction of propagation in the cw direction to reinforce the cw wave 92. This external facet thus causes the laser to favor operation in a cw direction and the light indicated by arrow 98 will be the dominant beam emitted.

As pointed out in U.S. Pat. No. 5,132,983, the distance between facet 88 and the surface 102 of external facet 100, and the angle of facet surface 102 with respect to the path of emergence, will determine how strongly the light will be propagated in the desired direction, for if the surface 102 of facet 100 is not exactly perpendicular to the path of emergence of beam 96, the effective reflectivity is lowered. The length of the external reflective facet surface 102 which faces the path of emergence of beam 96 also affects reflectivity, as does the shape of the surface.

The external reflective facet, or mirror, 100 causes laser 80 to operate in a unidirectional manner and allows the teardrop-shaped cavity to have a deterministic output that is important in optical circuits, for example. When the ring laser is a broad-area laser; that is, where there is no lateral confinement, the preferred location of the mirror 100 is determined by using Snell's Law, as illustrated in FIG. 3 by the angles 106 and 108. When the ring laser is laterally confined, the plane-wave approximation breaks down as the critical angle is approached, and the preferred position is determined through numerical modeling of the structure through the use of the Wave Equation.

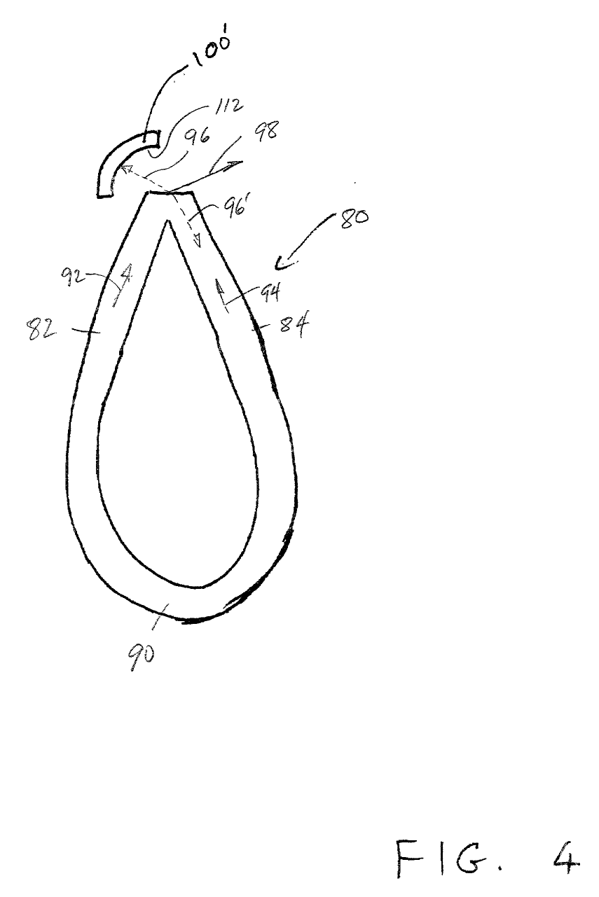

FIG. 4 illustrates the use of the ring laser 80 of FIG. 3 with an external reflective facet 100′ positioned outside the laser cavity and in the path of emergence of light beam 96. This facet differs, however, in that it has a curved surface 112 which reflects the emergent light back along the path of beam 96, as illustrated by dotted line 96′, and into the cavity 80, as described above, causing the ring laser to operate unidirectionally in a cw direction to produce emergent light beam 98. As in the laser of FIG. 3, this structure allows the teardrop-shaped cavity to have a deterministic output, with the curvature in the external mirror surface 112 providing compensation for light divergence in beam 96. It is noted that both the mirror 100 in the device of FIG. 3 anand the mirror 100′ in the device of FIG. 4 are formed using the same monolithic integration technology as is used in constructing the laser cavity.

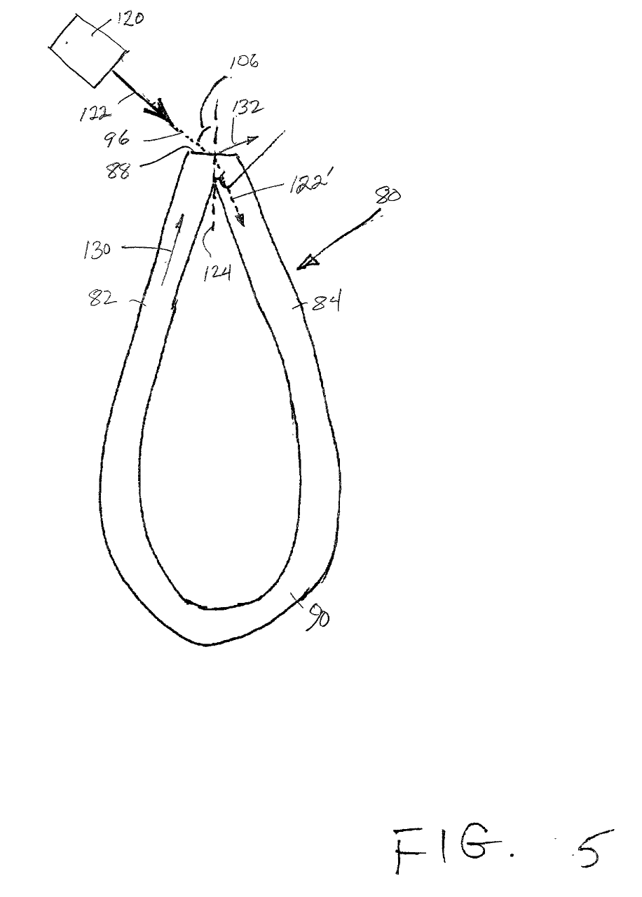

Another technique for forcing a curved waveguide semiconductor ring laser into a particular direction of propagation is through the use of injection-locking, where laser light is injected into the ring laser in the manner illustrated in FIG. 5. In this figure, the curved waveguide cavity laser 80 is provided with an external source 120 of laser light 122 directed toward facet 88 along the path of emergence of beam 96, described above. The source 120 thus directs light beam 122 onto facet 88 at an angle corresponding to the emergence angle 106, which is the angle between the direction of path 96 and dotted line 124, which is perpendicular to the surface of facet 88. A percentage of the injected light 122 is coupled into the laser structure 80 at facet 88, and propagates in the cavity 80 in a cw direction as indicated by the dotted line 122′. The exact percentage of the incident light which is coupled into the laser is dependent on the angle of incidence 106 and the distance of source 120 from the facet 88. The incident light causes unidirectional light wave propagation in laser 80, as indicated by arrow which produces the emitted light beam 132. Here again, when the ring laser is a broad-area laser, the preferred location of the injected light source 120 and its direction is determined by using Snell's Law; however, when the ring laser is laterally confined, the preferred position for light injection is determined through modeling.

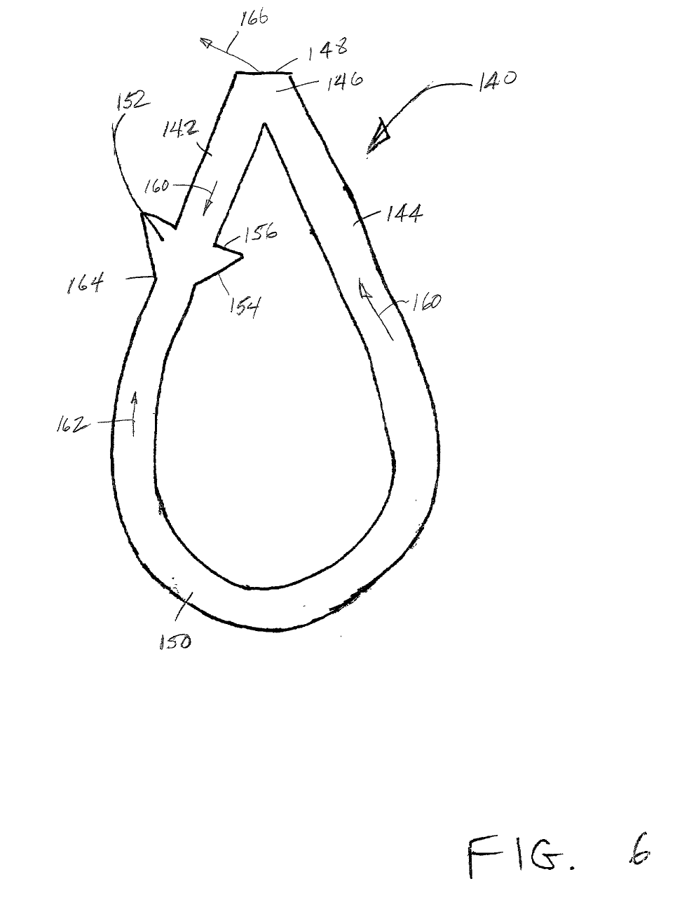

FIG. 6 illustrates in top diagrammatic plan view another technique for obtaining unidirectional circulating light in a ring laser to produce a unidirectional output from a teardrop-shaped laser 140. In this embodiment, the laser 140 includes straight cavity segments 142 and 144 joined at one end at a juncture 146 containing a facet 148 and joined at their second ends by a curved section 150, as described above. In this embodiment, unidirectional light is obtained by an asymmetric feedback structure 152 located, for example, in segment 142, in the manner described is U.S. Pat. No. 5,764,681, the disclosure of which is hereby incorporated herein by reference. Although there are a variety of ways to create an asymmetric coupling of bidirectional beams propagating in a ring laser, FIG. 6 illustrates the use of an asymmetric reflector; that is, a region 152 which produces different losses, depending on the direction of incidence of propagating light. As illustrated, the physically asymmetric transition region 152 is produced by fabricating the ring laser cavity with a tapering waveguide section wherein the waveguide widens very gradually over a given length, as indicated at 154, and then abruptly narrows to its original width, as at 156. Such a structure has higher loss for the light traveling in one direction as opposed to light traveling in the opposite direction so that the structure acts like an optical diode.

The structure illustrated in FIG. 6 provides preferential operation in the ccw direction, indicated by arrow 160, because the cw circulating laser light, indicated by arrow 162, arrives at the narrow end 164 of the outwardly tapering section 154 first. When this occurs, the lateral mode of the light beam 162 slowly expands as the waveguide width increases, until the abrupt shoulder portion 156 is reached. The sudden narrowing of the waveguide diode introduces loss to beam 162. On the other hand, the lateral mode of the ccw light beam 160 will experience a slight lateral expansion before the gradual tapering of the waveguide 152 forces the lateral mode into its original shape. This reinforcement favors the circulating direction toward which the diode is pointing; that is, the ccw direction, because beam 160 is attenuated less than the cw beam 162. This results in unidirectional light waves propagating in the direction of arrow 160, which produce emitted beam 166 at facet 148. This structure allows the teardrop-shaped cavity to have a deterministic output, as described above.

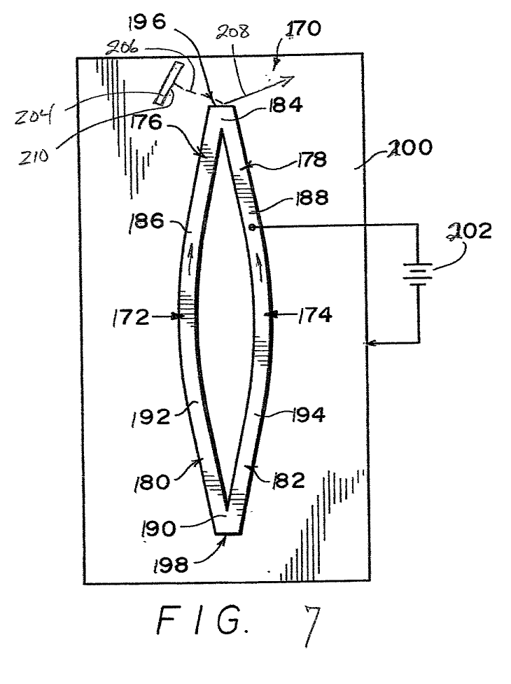

FIG. 7 illustrates another embodiment of a unidirectional ring laser utilizing curved waveguide segments. In this figure, a ring laser 170 incorporates two curved cavity sections 172 and 174 and four straight cavity sections 176, 178, 180 and 182 interconnected to form a ring-type cavity. The laser preferably is formed as a monolithic semiconductor structure on a substrate, as described above.

As illustrated, the first ends of linear cavity sections 176 and 178 are joined together at junction 184 and are connected at their second, or free ends 186 and 188, respectively, to corresponding ends of the curved sections 172 and 174. In similar manner, straight sections 180 and 182 are connected at first ends to junction region 190, with their free ends 192 and 194 respectively, connected to corresponding ends of the curved segments 172 and 174. A facet 196 is formed at the juncture of sections 176 and 178, while a facet 198 is similarly formed at the juncture of straight sections 180 and 182. Such a ring-type laser is described in greater detail in copending U.S. application Ser. No.______ of the applicant herein, filed on even date herewith and entitled “Curved Waveguide Ring Laser” (JTC Docket 104-128/BIN2).

In accordance with the present invention, the ring laser 170 incorporates a flat external reflective facet or mirror 204, which is positioned outside the laser cavity and is aligned with, and perpendicular to, an emergence path 206 for light traveling in the ring laser in a counterclockwise direction. This external mirror reflects light back into the ring cavity in the manner described above to produce unidirectional light propagating in the cavity and being emitted at facet 196 as indicated by emergence beam 208. Thus, the external mirror 204 causes the ring laser 170 to operate in a unidirectional manner and to have a deterministic output. When the ring laser is broad-area laser, the preferred location of mirror 204 is determined by Snell's Law, but when the laser is laterally confined, the modeling approach described above is used to determine the location of the mirror.

Although the mirror 204 is illustrated as having a flat reflective surface 210 it is understood that a curved surface may be utilized in the manner illustrated in FIG. 4 hereinabove. As described above, this external curved mirror also will cause the ring laser to operate in a unidirectional manner, and provides compensation for divergent light.

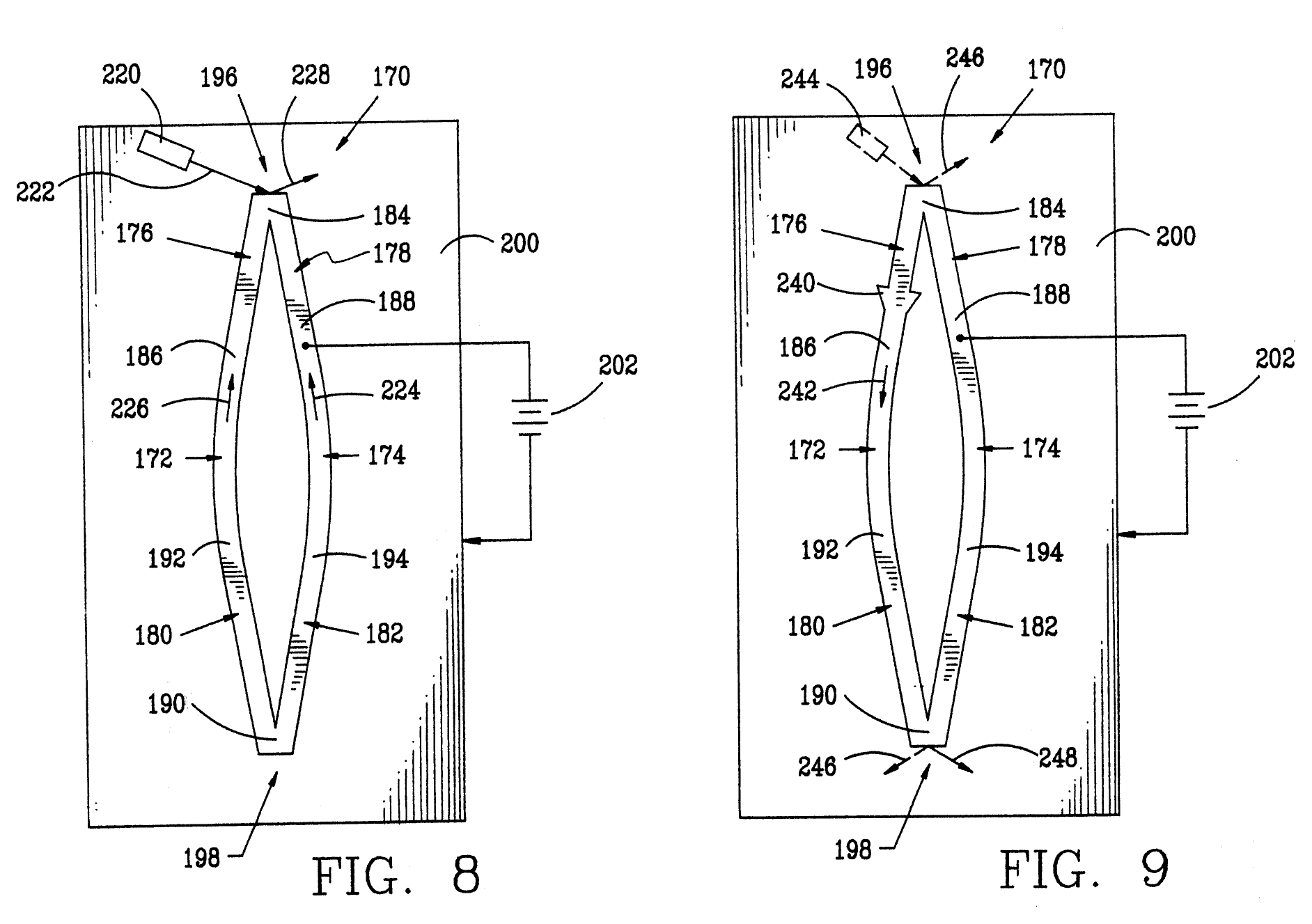

As described above with respect to FIG. 5, and illustrated in FIG. 8, the reflective mirror 204 may be replaced by an external source of laser light 220, producing a beam 222 which is directed at facet 196 along the emergence path of the counterclockwise beam indicated by arrow 224. This injected light 222 forces the ring laser to propagate in a clockwise direction, as illustrated by arrow 226, producing an emergent light beam 228. As described, the external source of light 220 causes the ring laser to operate in a unidirectional manner with a deterministic output, the preferred location of the inserted light beam 222 being determined by Snell's Law. Modeling is used when the ring laser is laterally confined, for then the plane-wave approximation breaks down as the critical angle is approached.

FIG. 9 illustrates in diagrammatic form a top plan view of another embodiment of the invention, wherein the ring laser 170 is provided with an asymmetrical element 240 of the type described above with respect to FIG. 6, to produce unidirectional propagation of light, for example in the ccw direction indicated by arrow 242.

The above-described embodiments illustrate the way in which a ring laser with at least one curved section and at least one facet can be made to operate unidirectionally through a variety of techniques. More complex ring laser cavities which incorporate a large number of facets and/or a large number of curved sections, can be made to operate in a unidirectional manner using similar techniques. Furthermore, these techniques can be combined in a ring laser to allow construction of a laser that can be forced into alternate deterministic outputs. For example, the laser of FIG. 9 can utilize, in addition to the illustrated internal asymmetric element 240, an external light source 244, illustrated in dotted lines. Such a light source, when operated, can force the laser 170 to operate unidirectionally in a cw direction to produce an output beam 246, with the asymmetric element 240 causing ccw unidirectional operation, illustrated by output 248, when the light source 244 is off.

Although the present invention has been illustrated in terms of preferred embodiments, it will be understood that variations and modifications may be made without departing from the true spirit and scope thereof, as set out in the following claims:

What is claimed is:

1. A waveguide structure comprising:
a facet;
at least one curved section for directing waves propagating in the waveguide to said facet; and
means for causing said waves to propagate unidirectionally.

2. The structure of claim 1, wherein said waveguide structure is a ring laser.

3. The structure of claim 2, wherein said facet is partially transmissive to emit at least a portion of said unidirectional radiation.

4. The structure of claim 1, wherein said facet is partially transmissive to emit at least a portion of said unidirectional radiation.

5. The structure of claim 1, wherein said structure is a ring laser cavity which propagates optical waves.

6. The structure of claim 5, wherein said means for causing said waves to propagate unidirectionally includes a reflector located externally of said ring cavity.

7. The structure of claim 6, wherein said reflector has a planar surface.

8. The structure of claim 6, wherein said reflector lies in the path of light emitted from said facet to reflect at least a portion of the emitted light back into said ring cavity.

9. The structure of claim 6, wherein said reflector has a curved surface.

10. The structure of claim 9, wherein said reflector lies is the path of light emitted from said facet.

11. The structure of claim 5, wherein said means for causing said waves to propagate unidirectionally includes an asymmetric element in said cavity.

12. The structure of claim 5, wherein said means for causing said waves to propagate unidirectionally includes a source of laser light located externally of said cavity and directing laser light into said cavity.

13. The structure of claim 12, wherein said source of laser light is located to direct a beam of light into said cavity through said facet.

14. The structure of claim 13, wherein said source of light is aligned with, and is opposed to, light emitted from said facet.

15. The structure of claim 5, wherein said means for causing said waves to propagate unidirectionally includes at least first and second alternately operable means, whereby the direction of propagation is selectively reversible.

16. An optical guiding structure comprising:
a facet;
at least one curved waveguide section for directing light to propagate to said facet; and
at least one optical device for causing said waves to propagate unidirectionally.

17. The structure of claim 16, wherein said optical device is external of said waveguide section.

18. The structure of claim 17, wherein said optical device is a reflective surface.

19. The structure of claim 17, wherein said optical device is a light source.

20. The structure of claim 16, wherein said optical device is located within said waveguide section.

21. The structure of claim 20, wherein said optical device is an asymmetric element.

22. The structure of claim 16, wherein said optical device includes a reflective surface adjacent said facet and a light source for directing light into said curved waveguide section.
